(19) United States
(12) Patent Application Publication
(10) Pub. No.: US 2007/0240347 A1
(43) Pub. Date: Oct. 18, 2007

(54) Flat panel display elevating apparatus

(76) Inventor: Warren Chang, Los Angeles, CA (US)

Correspondence Address: PATENT LAW & VENTURE GROUP, 2424 S.E. BRISTOL, SUITE 300, NEWPORT BEACH, CA, 92660, US

(21) Appl. No.: 11/405,048

(22) Filed: Apr. 17, 2006

(51) Int. Cl. G09F 7/00; A47H 1/10; B66D 1/12

(52) U.S. Cl. 40/601; 254/362; 248/329

(57) ABSTRACT

A vertically oriented support frame engages a vertically oriented traveling frame for movement between a retracted position, wherein the traveling frame is positioned in front of the support frame, and an extended position wherein the traveling frame is positioned primarily above the support frame. An electric motor is fixed to the support frame and rotates a drive screw engaged with the support frame while the traveling frame is engaged with the drive screw so as to be moved vertically as the drive screw rotates. Upper and lower limit switches sense when the traveling frame is in the extended position and in the retracted position and send signals to a motor control to stop the motor.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”

Not applicable.

### BACKGROUND OF THE INVENTION

1. Field of the Present Disclosure

This disclosure relates generally to machines for positioning display screens and more particularly to such machines that are capable of being remotely operated and of lifting relatively heavy displays from a stored position within a cabinet to an exposed position above such a cabinet.

2. Description of Related Art Including Information Disclosed under 37 CFR 1.97 and 1.98

O'Neil U.S. Pat. No. 5,310,152, discloses a television mounting frame with a removable lifting assembly for facilitating the installation of heavy equipment, particularly large televisions. A television or the like is affixed to a lower frame yolk. An upper frame yolk, which complimentarily engages with the lower yolk to form a complete frame, is mounted to an overhead structure via a hanger pipe attached to a mounting bracket. A lifting assembly is removably affixed to the hanger pipe and disposed so that the winch cable may unwind from the winch and through the hanger pipe for attachment to the television mounted on the lower frame yolk. Once attached to the cable, the television may be lifted into engagement with the upper frame yolk without the use of large and cumbersome scaffolding systems or many assistants. The winch assembly may then be removed for use in the installation of other equipment to different mounting brackets. Huffman, U.S. Pat. No. 5,261,645, and U.S. Pat. No. 5,366,203 disclose a remote control, ceiling mounted lifting device for concealing, supporting and providing floor level access to audio visual objects such as color video/data projectors. The overall height of the lifting device is extremely shallow to allow the device to be mounted and concealed within the ceiling clearance area. The device has an outer frame with an open inner section. A support carriage is provided which is sized to fit and nest with the open inner section of the support framework. The carriage has an inverted U-shaped structure which allows the projector to be recessed upwardly within the confines of the carriage. A scissor-like stabilizer mechanism is mounted on each side of the carriage and support structure. These stabilizer mechanisms are located on the outer edges of the device to minimize the overall height of the device. This double linkage mechanism stabilizes the carriage during movement and use and yet allows the projector to be recessed within the ceiling structure when the carriage is retracted. Cable supports on either side of the carriage are mounted to a motor driven cable drum assembly which is laterally positioned at the top of the support structure. The drum mechanism is positioned to substantially align with the center of gravity of the loaded carriage. An emergency locking brake assembly is provided in conjunction with the cable drum to prevent the carriage from dropping in an emergency situation. A low voltage remote control system which can use infrared sensors for signal transmission is used for controlling the operation of the lifting device. Alexander, III et al., U.S. Pat. No. 4,941,718, discloses an apparatus for housing articles between a ceiling and a roof, utilizing a switch means for actuating suitable electrically operated pivoting means for retracting the apparatus into the ceiling and lowering it from the ceiling. Gustaveson, et al., U.S. Pat. No. 4,843,782, discloses mounting a television receiving set behind the ceiling of a room, such as a bedroom, for viewing by a person reclining or sitting with head back, is made by a support portion of a protective housing positioned or adapted to be positioned behind a viewing opening in the ceiling of the room and sloping upwardly from such opening. The viewing opening is normally closed by a ceiling panel hinged as a door along its forward end, but can be opened for viewing of or projection by the television receiver by remote-controlled mechanism operative to raise and lower the panel door on its hinging axis, which is preferably free. The mechanism is arranged to pull a flexible draw line for raising the panel door and to slacken such line so the panel can return to closed position by the force of gravity. So as to seat properly in closed position, the panel door is a sheet of pliable material having sufficient rigidity to be shape retaining, preferably a one-quarter inch thick, medium density fibreboard, it and the viewing opening and door-seating structure that is peripheral marginally of the panel door preferably being of rectangular configuration and the upper surface of the ceiling panel door being reinforced peripherally inwardly of the seating margins and, depending upon shape and size of the panel door, also longitudinally intermediate the width of such door by mutually independent lengths of rigid material, such as structural steel angles which do not intersect. For easy removal through the viewing opening when the mechanism is mounted on top of the housing and the panel door removed, such housing is provided with an opening at least commensurate in size with the mechanism and the mechanism is mounted on a base plate that is removably secured across the opening. Lloyd, Sr. et al., U.S. Pat. No. 4,750,832, discloses a projector mounting frame that is fitted in the space above the suspended ceiling of a room. A traveling frame vertically movable in the mounting frame has means for support of a projector thereon. Drive motor and screws drive the traveling frame vertically so the projector can be driven from a position concealed within the space above the ceiling to a position below the ceiling where it can project onto a wall or screen in the room. A trim frame is hung on the traveling frame under the projector and has ceiling pads or tiles on it matching the rest of the ceiling to neatly close the ceiling opening when the projector is concealed. Dittman, U.S. Pat. No. 6,585,214, discloses an extended travel lift system that includes a support frame and a display device frame. First and second arms are connected at first ends thereof by a hinge connector. A second end of the first arm is pivotally attached to a first slide mechanism on the support frame and a second end of the second arm is pivotally attached to the support frame. Third and fourth arms are connected at first ends thereof by the hinge connector. A second end of the third arm is pivotally attached to a second slide mechanism on the display device frame and a second end of the fourth arm is pivotally attached to the display device frame. A biasing mechanism is provided to bias the display device frame to an extended position. A height control mechanism is provided to retain the display device frame in either a retracted position or the extended position. The first and second arms are typically located in a first plane and the third and fourth arms are located in a second plane parallel to the first plane. Graetz, U.S. Pat. No. 5,833,198, discloses a lift table that includes a support table assembly mounted on a scissor arm mechanism. The support table assembly is raised and lowered automatically upon the imposition or removal of loads so that the height of the plane on which articles are being handled remains generally constant. Raising and lowering is effected via a lift spring assembly that acts without the assistance of any pneumatic or hydraulic actuators. The scissor arm mechanism of the lift table has angled arms and low-friction rollers to facilitate raising and lowering of the support table assembly and optimizing operation of the lift spring assembly. The resulting mechanically operated lift table is simple, reliable, and can be easily transported from location to location.

The related art described above discloses several lifting devices. However, the prior art fails to disclose any devices that are related to the instant apparatus described herein. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

Large flat panel display devices such as plasma a large LCD units are considered to be unsightly when present in a residence of fine furniture and upscale design. It is therefore necessary to disguise or otherwise enable such displays to be removed from sight at times when they are not being used. The prior art teaches that it is possible to store displays within cabinets and to mechanically raise them for viewing and lower them for storage. The presently described apparatus teaches a novel and low cost construction of a device for raising and lowering a flat panel display. In this apparatus, a vertically oriented support frame engages a vertically oriented traveling frame for movement between a retracted position, wherein the traveling frame is positioned in front of the support frame, and an extended position wherein the traveling frame is positioned primarily above the support frame. An electric motor is fixed to the support frame and rotates a drive screw engaged with the support frame while the traveling frame is engaged with the drive screw so as to be moved vertically as the drive screw rotates. Upper and lower limit switches sense when the traveling frame is in the extended position and in the retracted position and send signals to a motor control to stop the motor.

A primary objective inherent in the above described apparatus and method of use is to provide advantages not taught by the prior art.

Another objective is to provide a low cost flat panel display lifting device enabling storage of the display within a cabinet when not in use.

A further objective is to provide such a lifting device that is able to mount a flat panel display by simply engaging it over an edge of the lifting device so that it may be installed and removed quickly and easily.

A further objective is to provide such a lifting device with a cabinet having a narrow door mounted on a top panel that is lifted into an open state by the lifting device and which closes upon retracting the display.

A still further objective is to provide such a lifting device that is essentially incapable of trapezoid binding during operation.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view the instant apparatus with a partial cutaway portion revealing a drive belt engagement with a drive sprocket;

FIG. 2 is a similar view to that of FIG. 1 showing a frame thereof moving upwardly on a base portion thereof;

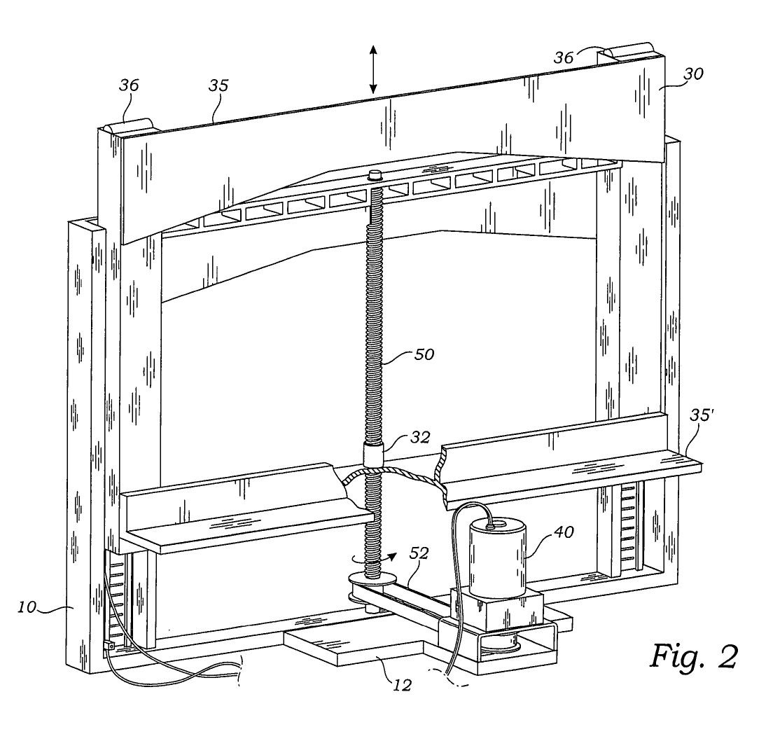

FIG. 3 is a similar view to that of FIG. 1 showing a pair of mounting straps thereof and in phantom line, a flat panel display for engagement with the straps;

FIG. 4 is a similar view to that of FIG. 3 showing the straps and display as mounted onto the frame;

FIG. 5 is a similar view to that of FIG. 4 showing a control box, and, in phantom line, a cabinet; and

FIG. 6 is a similar view to that of FIG. 5 showing the frame and display in an elevated position extending above the cabinet.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

The presently described apparatus is used for raising and lowering a flat panel display such as the plasma and LCD displays that are used with computers and television broadcast tuners, for instance. The apparatus may include a variety of components and such may be mutually engaged in various ways, but one preferred embodiment of the present apparatus includes the raising and lowering apparatus only, for in fact, in may be used by itself or may be enclosed within many different types of equipment, while a second embodiment includes a particular cabinet for enclosing the raising and lowering apparatus.

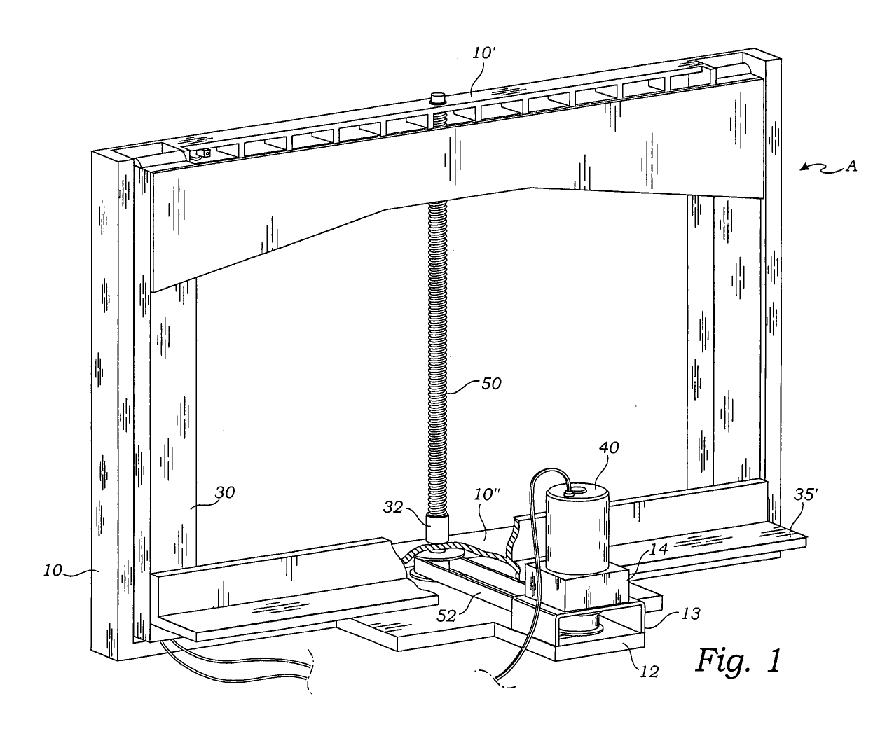

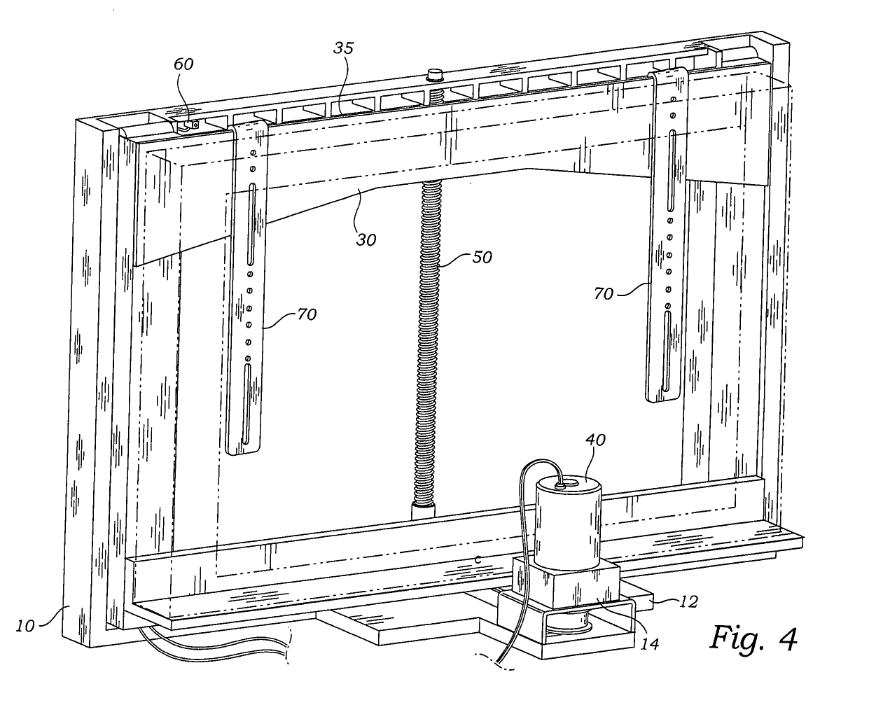

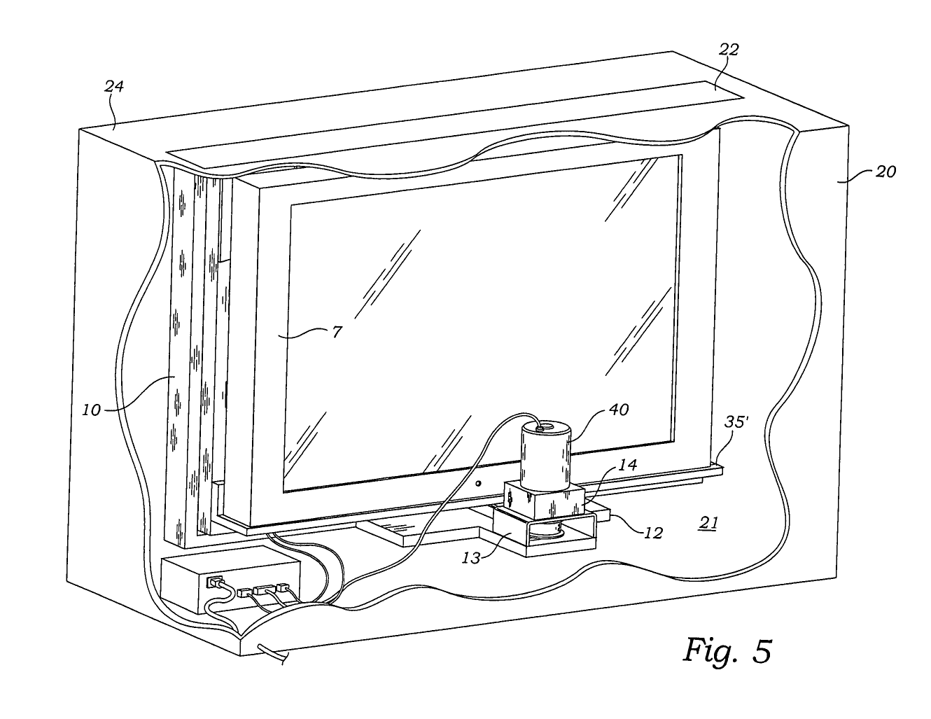

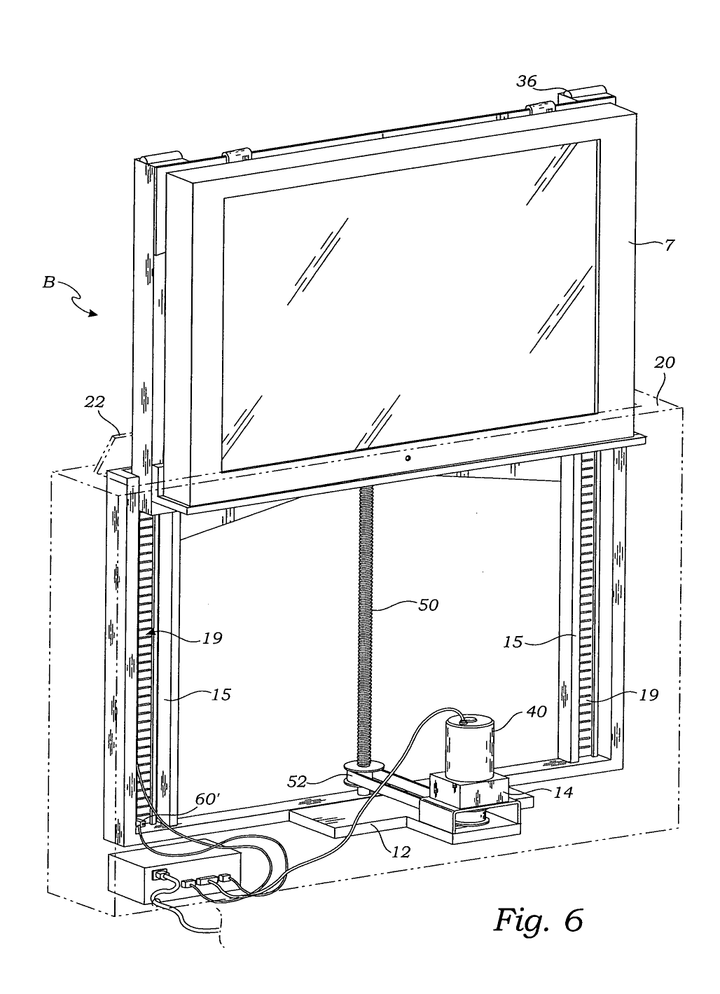

A vertically oriented support frame 10 is fixedly mounted to a supporting surface 21 such as provided by cabinet 20 (FIG. 6) which encloses the support frame 10. The cabinet 20 has a hinged door 22 on an upper panel 24 thereof, and the function of this door 22 will be described presently. A vertically oriented traveling frame 30 is engaged with the support frame 10, as will be described in detail below, and is enabled thereby for movement between a retracted position “A” (FIGS. 1, 4 and 5), and an extended position “B” (FIG. 6). When the traveling frame 30 is in the retracted position, the hinged door 22 is closed, and the traveling frame 30 is positioned in front of the support frame 10. When the traveling frame 20 is in the extended position “B”, it is positioned primarily above the support frame 10 as well as the upper panel 24 of the cabinet 20, and the hinged door 22 is open as shown in FIG. 6. A set of bumpers 36 are mounted on the traveling frame 30 and contact the door 22 as the frame 30 emerges from the cabinet 20. The door 22 rests against the traveling frame 30 as it moves to its uppermost end position and also as it moves down into the cabinet 20. Bumpers 36 have curved surfaces which are in contact with door 22 so as to enable the door to close smoothly as the traveling frame 30 enters the cabinet 20.

An electric motor 40 is fixed to the support frame 10 by horizontal support plate 12 and bracket 13 as shown, but the motor 40 might alternatively be mounted in a vertical orientation as would be enabled by one of skill in the art. A reduction gear box 14 may be used as shown in FIG. 1. A linear drive screw 50 is rotationally engaged with the support frame 10 in a position medial between the linear slides, and extends vertically between a lower horizontal strut 10′ and an upper horizontal strut 10″ of the support frame 10. The motor 40 is engaged with the drive screw 50 preferably by a drive belt 52 for rotation of the screw 50.

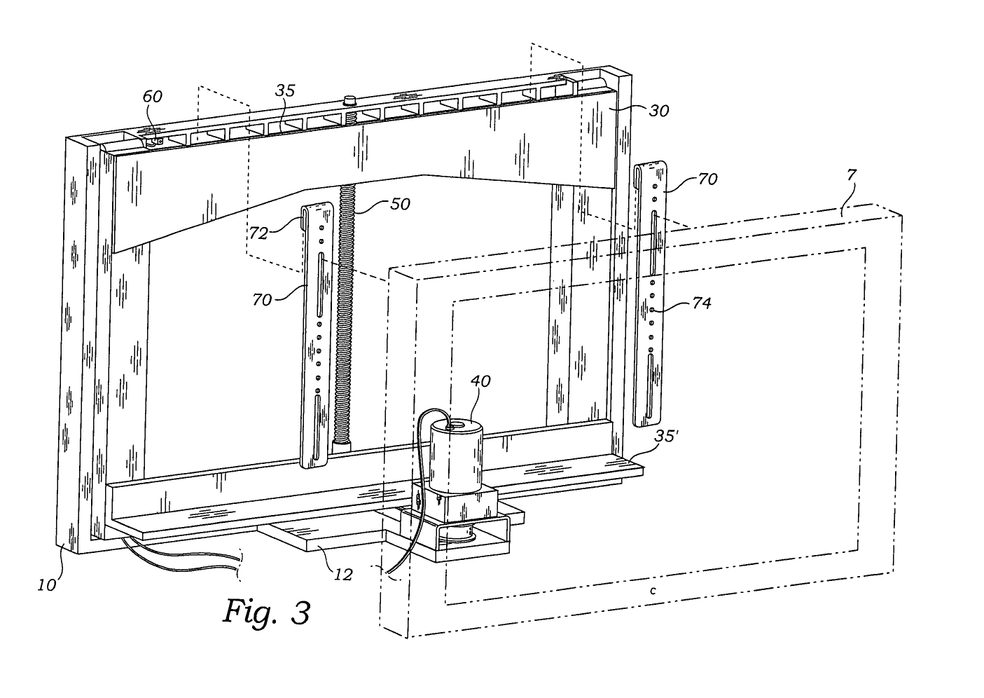

The traveling frame 30 is engaged with the drive screw 50 by a captured nut 32 so as to be moved vertically as the drive screw 30 rotates. Upper 60 (FIG. 3) and a lower 60′ (FIG. 6) mechanical limit switches are engaged with the support frame 10 in positions where the traveling frame 30 contacts them in its extreme positions of motion such that the switches 60′ and 60″, when contacted by the traveling frame 30, disengage power to the motor 40 and reverse motion. Such circuits, using relays, are very well known in the arts and so are not described herein. See, for instance, the Encyclopedia of Electronic Circuits by Rudolf F. Graf, 1985 by Tab Books a division of McGraw-Hill, Inc. for circuits enabling sensing of the traveling frame 30 when in the extended position “B” and in the retracted position “A.”

The apparatus further comprises at least one, and most preferably two display supporting straps 70 which are removably engagable with the traveling frame 30. The straps 70 each provide a gripping element 72 at an upper terminal end, and these gripping elements are enabled for engaging an upper edge 35 of the traveling frame 30 as shown in FIG. 3. Preferably, the gripping element 72 is a U-shaped clamp. The supporting strap 70 is enabled by screw holes 74 or the like for removable attachment to a flat panel display 7.

Preferably, the traveling frame 30 provides a horizontal support surface 35′ for receiving a flat panel display 7 in supporting rest thereon.

Preferably, the support frame 30 is engaged with the traveling frame 10 by linear slides 15 such as are in common use in cabinets for mounting drawers so that the drawers can be pulled out for access and then pushed into the cabinet for storage. Such slides are typically made of two mutually engaged channels of steel with roller or ball bearings mounting an inner one of the channels to an outer one of the channels in near frictionless linear sliding. In the present apparatus the outer channel is engaged with one of either the support frame 10 or the traveling frame 30 and the inner channel is engaged with the other so that the traveling frame 30 is able to move vertically while being held securely with essentially no sideways movement. Therefore, the present solution the lifting of a relatively heavy display device 7 without the possibility of jamming in its supports.

The linear slides preferably comprise two sets of linear slides 15 with one of the sets of liner slides 15 engaged on each of opposing sides of the traveling frame 30. In this case the support frame provides a vertical recess 19 on each of two opposing sides thereof, the linear slides engaged therein.

Preferably, both the support frame 10 as well as the traveling frame 30 are made of and engineering plastic preferably by the injection molding process so that they are made inexpensively and with considerable strength.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A flat panel display elevating apparatus comprising: a vertically oriented support frame; a vertically oriented traveling frame; the traveling frame engaged with the support frame for movement between a retracted position, wherein the traveling frame is positioned in front of the support frame, and an extended position wherein the traveling frame is positioned primarily above the support frame; an electric motor fixed to the support frame; a drive screw rotationally engaged with the support frame and extending vertically between a lower horizontal strut of the support frame and an upper horizontal strut of the support frame; the motor engaged with the drive screw for rotation thereof; the traveling frame engaged with the drive screw so as to be moved vertically as the drive screw rotates; and an upper and a lower limit switches engaged with the support frame in positions enabling sensing when the traveling frame is in the extended position and in the retracted position.

2. The apparatus of claim 1 further comprising at least one display supporting strap, the strap removably engagable with the traveling frame.

3. The apparatus of claim 2 wherein the at least one display supporting strap provides a gripping element at an upper terminal end thereof, the gripping element enabled for engaging an upper edge of the traveling frame.

4. The apparatus of claim 3 wherein the gripping element is a U-shaped clamp.

5. The apparatus of claim 2 wherein the supporting strap is enabled for removable attachment to a flat panel display.

6. The apparatus of claim 1 wherein the traveling frame provides a horizontal support surface for receiving a flat panel display in supporting rest thereon.

7. The apparatus of claim 1 wherein the support frame is engaged with the traveling frame by linear slides.

8. The apparatus of claim 7 wherein the linear slides comprise two sets of linear slides with one of the sets of liner slides engaged on each of opposing sides of the traveling frame.

9. The apparatus of claim 8 wherein the support frame provides a vertical recess on each of two opposing sides thereof, the linear slides engaged therein.

10. The apparatus of claim 8 wherein the drive screw is positioned medially between the linear slides.

11. A flat panel display elevating apparatus comprising: a vertically oriented support frame fixedly mounted within a cabinet, the cabinet having a hinged door on an upper panel thereof, a vertically oriented traveling frame; the traveling frame engaged with the support frame for movement between a retracted position wherein the hinged door is closed, and wherein the traveling frame is positioned in front of the support frame, and an extended position wherein the traveling frame is positioned primarily above the support frame and the upper panel of the cabinet, and wherein the hinged door is open; an electric motor fixed to the support frame; a drive screw rotationally engaged with the support frame and extending vertically between a lower horizontal strut of the support frame and an upper horizontal strut of the support frame; the motor engaged with the drive screw for rotation thereof; the traveling frame engaged with the drive screw so as to be moved vertically as the drive screw rotates; and an upper and a lower limit switches engaged with the support frame in positions enabling sensing when the traveling frame is in the extended position and in the retracted position.

12. The apparatus of claim 11 further comprising at least one display supporting strap, the strap removably engagable with the traveling frame.

13. The apparatus of claim 12 wherein the at least one display supporting strap provides a gripping element at an upper terminal end thereof, the gripping element enabled for engaging an upper edge of the traveling frame.

14. The apparatus of claim 13 wherein the gripping element is a U-shaped clamp.

15. The apparatus of claim 12 wherein the supporting strap is enabled for removable attachment to a flat panel display.

16. The apparatus of claim 11 wherein the traveling frame provides a horizontal support surface for receiving a flat panel display in supporting rest thereon.

17. The apparatus of claim 11 wherein the support frame is engaged with the traveling frame by linear slides.

18. The apparatus of claim 17 wherein the linear slides comprise two sets of linear slides with one of the sets of liner slides engaged on each of opposing sides of the traveling frame.

19. The apparatus of claim 18 wherein the support frame provides a vertical recess on each of two opposing sides thereof, the linear slides engaged therein.

20. The apparatus of claim 18 wherein the drive screw is positioned medially between the linear slides.
